(19) United States
(12) Patent Application Publication
(10) Pub. No.: US 2003/0005159 A1
(43) Pub. Date: Jan. 2, 2003

(54) Method and system for generating and serving multilingual web pages

(75) Inventor: David Bruce Kumhyr, Austin, TX (US)

Correspondence Address: Joseph R. Burwell, Law Office of Joseph R. Burwell, P.O. Box 28022, Austin, TX, 78755-8022, US

(73) Assignee: INTERNATIONAL BUSINESS MACHINES CORPORATION, ARMONK, NY (US)

(21) Appl. No.: 09/875,862

(22) Filed: Jun. 7, 2001

(51) Int. Cl. G06F 15/16; G06F 17/00

(52) U.S. Cl. 709/246; 707/531; 707/513

(57) ABSTRACT

A method, a system, an apparatus, and a computer program product are presented for publishing multilingual content through a Web site using language-neutral Web pages. Instead of creating multiple, language-specific, Web pages for each Web page that contains content, a single, language-neutral, Web page is maintained, and the language-specific content strings for the language-neutral Web page are dynamically retrieved in accordance with the user's selection of a preferred language, which can be received at a server supporting the Web site via a Web page request message from a client. The language-neutral Web page contains at least one content directive that identifies a content key. Using the content key and the user-specified language preference parameter, a content string is retrieved from a datastore and inserted into modified version of the language-neutral document, thereby generating a language-specific content stream.

### BACKGROUND OF THE INVENTION

1. Field of the Invention

The present invention relates to an improved data processing system and, in particular, to a method and apparatus for document processing. Still more particularly, the present invention provides a method and apparatus for generating multilingual documents.

2. Description of Related Art

Distribution of information across the Internet has continued to increase dramatically. World Wide Web-based and Internet-based applications and services have now become so commonplace that when one learns of a new technology product or service, one assumes that the product or service will incorporate Internet or Web functionality in some manner into the product or service. Many corporations have employed proprietary data services for many years, but it is now commonplace to assume that individuals and small enterprises also have access to Internet services.

One of the factors influencing the growth of the Internet is the adherence to open standards for much of the Internet infrastructure. Individuals, public institutions, and commercial enterprises alike are able to introduce new content that is quickly integrated into the digital infrastructure because of their ability to exploit common knowledge of open standards. Many commercially available word processing programs can output documents that are formatted with various types of markup languages, and these documents can be immediately published onto the Web so that they are available through the Web to anyone with a browser application.

Most publishers, whether an individual or an organization, generally desire to reach the broadest audience for whatever content or information that they publish on the Web. Given the nature of the Internet, the reach of the Internet continues to expand internationally. One can assume that almost anyone in the world may be able to view a particular Web site.

In order to communicate effectively with an international audience, the content of a Web site should be translated for different markets, regions, or countries. Many tasks must be completed in order to prepare a Web site for a particular localized audience. However, even without translation costs, development and maintenance of Web sites can require significant time and effort, particularly if the content of the Web site changes frequently. Adapting a Web site for local markets could entail costly and time-consuming modifications to a Web site. Many publishers may decide not to spend any money on translation costs in light of a possibly minimal benefit in doing so.

If a publisher does decide to operate a Web site in more than one language, then the usual course of action is to publish a set of similar, language-specific Web pages that branch from a common home page. Sets of related Web pages are published in different languages in which the related Web pages have a common appearance and layout but have content translated into different languages. From a language perspective, similar Web pages are available in parallel with multiple, language-specific Web pages existing for each Web page that contains content. Hence, in order to maintain a multilingual Web site, a publisher may experience an increase in effort and costs that are linearly proportional to the number of languages that the Web site contains.

Therefore, it would be advantageous to have a methodology for facilitating content maintenance on a Web site in multiple languages.

### SUMMARY OF THE INVENTION

A method, a system, an apparatus, and a computer program product are presented for publishing multilingual content through a Web site using language-neutral Web pages. Instead of creating multiple, language-specific, Web pages for each Web page that contains content, a single, language-neutral, Web page is maintained, and the language-specific content strings for the language-neutral Web page are dynamically retrieved in accordance with the user's selection of a preferred language, which can be received at a server supporting the Web site via a Web page request message from a client. The language-neutral Web page contains at least one content directive that identifies a content key. Using the content key and the user-specified language preference parameter, a content string is retrieved from a datastore and inserted into modified version of the language-neutral document, thereby generating a language-specific content stream. The content directive may also include a datastore identifier that identifies a particular datastore from which to retrieve the content string. The methodology of generating the language-specific content stream is compatible with standard protocols and commercially available browser applications.

### BRIEF DESCRIPTION OF THE DRAWINGS

The novel features believed characteristic of the invention are set forth in the appended claims. The invention itself, further objectives, and advantages thereof, will be best understood by reference to the following detailed description when read in conjunction with the accompanying drawings, wherein:

FIG. 1A depicts a typical distributed data processing system in which the present invention may be implemented;

FIG. 1B depicts a typical computer architecture that may be used within a data processing system in which the present invention may be implemented;

FIG. 2A is a block diagram depicting an organization of Web pages that may be used to publish multilingual content within a single Web site;

FIG. 2B is a diagram depicting a set of typical HTML source documents for a multilingual set of Web pages;

FIG. 2C is a diagram depicting a typical graphical user interface (GUI) window through which a user may set preference parameters for a browser application;

FIG. 2D is a diagram depicting a trace of a typical HTTP GET message;

FIG. 2E is a diagram depicting a typical browser application window;

FIG. 3A is a block diagram depicting an organization of language-neutral Web pages that may be used to publish multilingual content within a single Web site in accordance with the present invention;

FIG. 3B is a block diagram depicting a data processing system that may be used to store language-neutral Web pages that support the presentation of a multilingual Web site in accordance with the present invention;

FIG. 4 is a diagram depicting a language-neutral HTML source document that may be used to provide multiple language-specific versions of a Web page in accordance with the present invention;

FIG. 5 is a block diagram depicting a language-specific content string retrieval process in accordance with a preferred embodiment of the present invention; and

FIG. 6 is a flowchart depicting a process for generating language-specific Web pages using a language-specific content string retrieval process in conjunction with a language-neutral Web page in accordance with a preferred embodiment of the present invention.

### DETAILED DESCRIPTION OF THE INVENTION

The present invention is directed to a system and a methodology for generating multilingual Web pages. These Web pages may be obtained from one or more servers that are dispersed throughout a network. As background, a typical organization of hardware and software components within a distributed data processing system is described prior to describing the present invention in more detail.

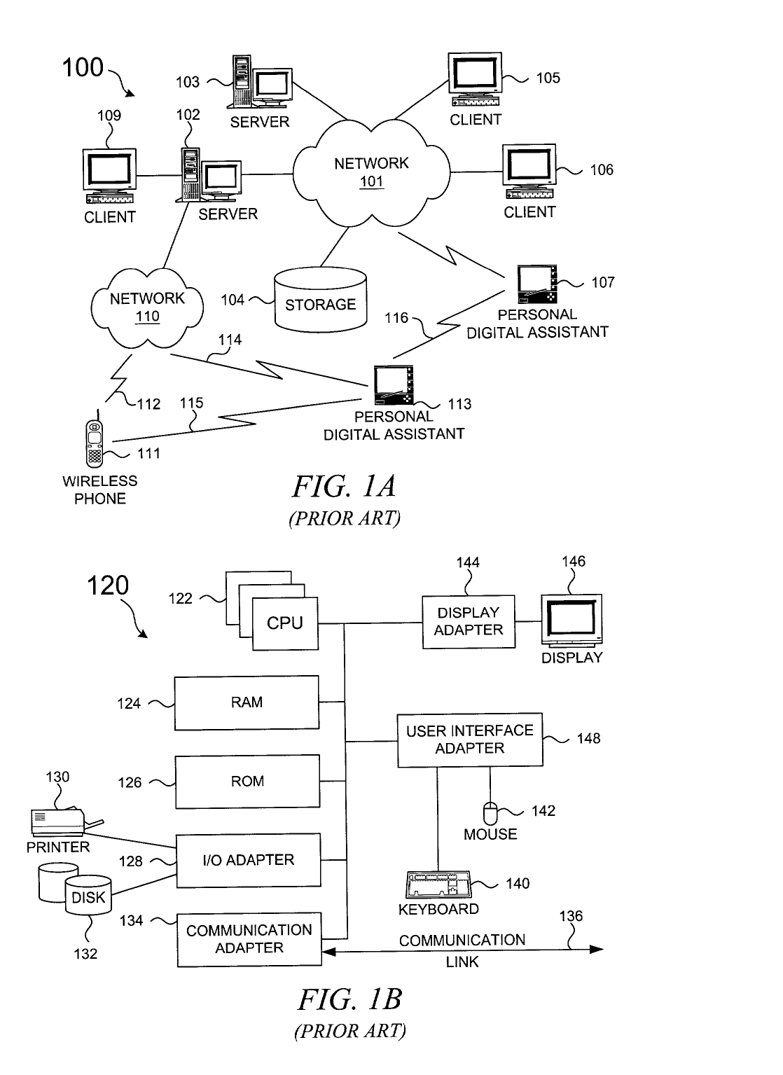

With reference now to the figures, FIG. 1A depicts a typical network of data processing systems, each of which may contain and/or operate the present invention. Distributed data processing system 100 contains network 101, which is a medium that may be used to provide communications links between various devices and computers connected together within distributed data processing system 100. Network 101 may include permanent connections, such as wire or fiber optic cables, or temporary connections made through telephone or wireless communications. In the depicted example, server 102 and server 103 are connected to network 101 along with storage unit 104. In addition, clients 105-107 also are connected to network 101. Clients 105-107 and servers 102-103 may be represented by a variety of computing devices, such as mainframes, personal computers, personal digital assistants (PDAs), etc. Distributed data processing system 100 may include additional servers, clients, routers, other devices, and peer-to-peer architectures that are not shown.

In the depicted example, distributed data processing system 100 may include the Internet with network 101 representing a worldwide collection of networks and gateways that use various protocols to communicate with one another, such as Lightweight Directory Access Protocol (LDAP), Transport Control Protocol/Internet Protocol (TCP/IP), Hypertext Transport Protocol (HTTP), Wireless Application Protocol (WAP), etc. Of course, distributed data processing system 100 may also include a number of different types of networks, such as, for example, an intranet, a local area network (LAN), or a wide area network (WAN). For example, server 102 directly supports client 109 and network 110, which incorporates wireless communication links. Network-enabled phone 111 connects to network 110 through wireless link 112, and PDA 113 connects to network 110 through wireless link 114. Phone 111 and PDA 113 can also directly transfer data between themselves across wireless link 115 using an appropriate technology, such as Bluetooth™ wireless technology, to create so-called personal area networks (PAN) or personal ad-hoc networks. In a similar manner, PDA 113 can transfer data to PDA 107 via wireless communication link 116.

The present invention could be implemented on a variety of hardware platforms; FIG. 1A is intended as an example of a heterogeneous computing environment and not as an architectural limitation for the present invention.

With reference now to FIG. 1B, a diagram depicts a typical computer architecture of a data processing system, such as those shown in FIG. 1A, in which the present invention may be implemented. Data processing system 120 contains one or more central processing units (CPUs) 122 connected to internal system bus 123, which interconnects random access memory (RAM) 124, read-only memory 126, and input/output adapter 128, which supports various I/O devices, such as printer 130, disk units 132, or other devices not shown, such as a audio output system, etc. System bus 123 also connects communication adapter 134 that provides access to communication link 136. User interface adapter 148 connects various user devices, such as keyboard 140 and mouse 142, or other devices not shown, such as a touch screen, stylus, microphone, etc. Display adapter 144 connects system bus 123 to display device 146.

Those of ordinary skill in the art will appreciate that the hardware in FIG. 1B may vary depending on the system implementation. For example, the system may have one or more processors, including a digital signal processor (DSP) and other types of special purpose processors, and one or more types of volatile and non-volatile memory. Other peripheral devices may be used in addition to or in place of the hardware depicted in FIG. 1B. The depicted examples are not meant to imply architectural limitations with respect to the present invention.

In addition to being able to be implemented on a variety of hardware platforms, the present invention may be implemented in a variety of software environments. A typical operating system may be used to control program execution within each data processing system. For example, one device may run a Unix® operating system, while another device contains a simple Java® runtime environment. A representative computer platform may include a browser, which is a well known software application for accessing hypertext documents in a variety of formats, such as graphic files, word processing files, Extensible Markup Language (XML), Hypertext Markup Language (HTML), Handheld Device Markup Language (HDML), Wireless Markup Language (WML), and various other formats and types of files.

The present invention may be implemented on a variety of hardware and software platforms, as described above. Prior to describing the present invention in more detail, a typical multilingual Web site is described with background information on the manner in which multilingual Web sites are generally operated.

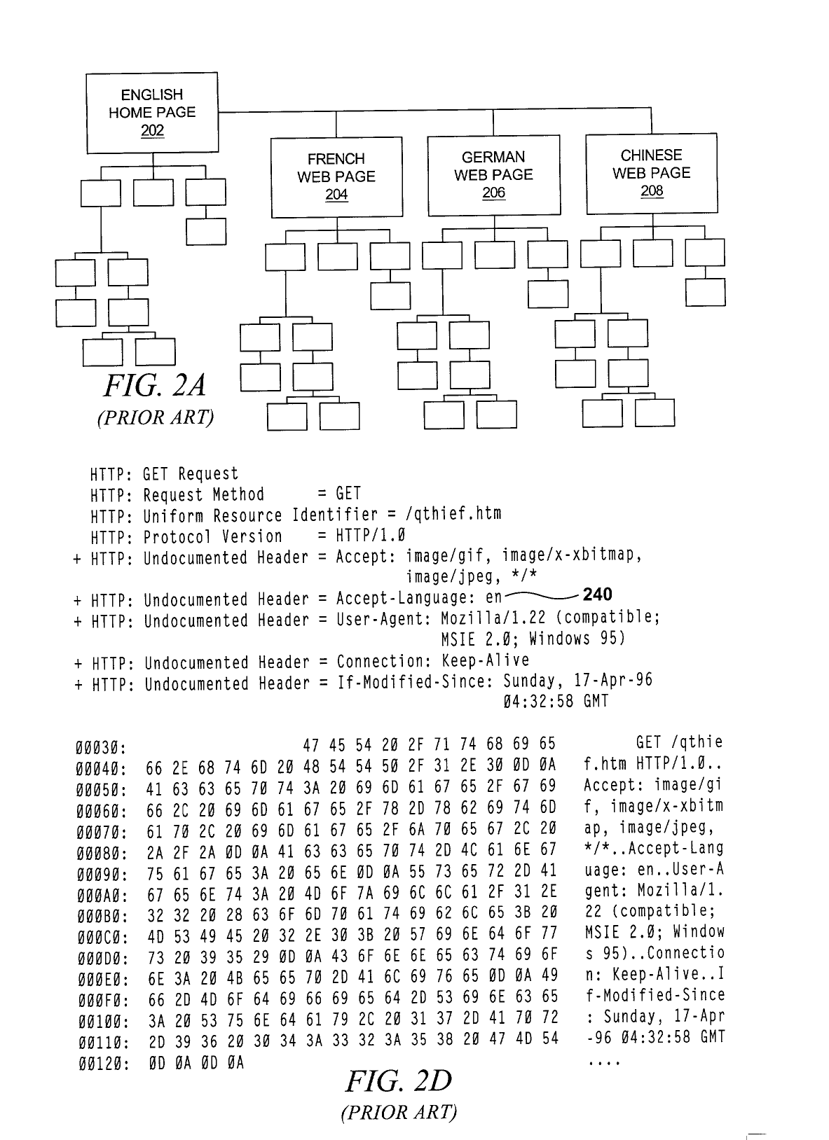

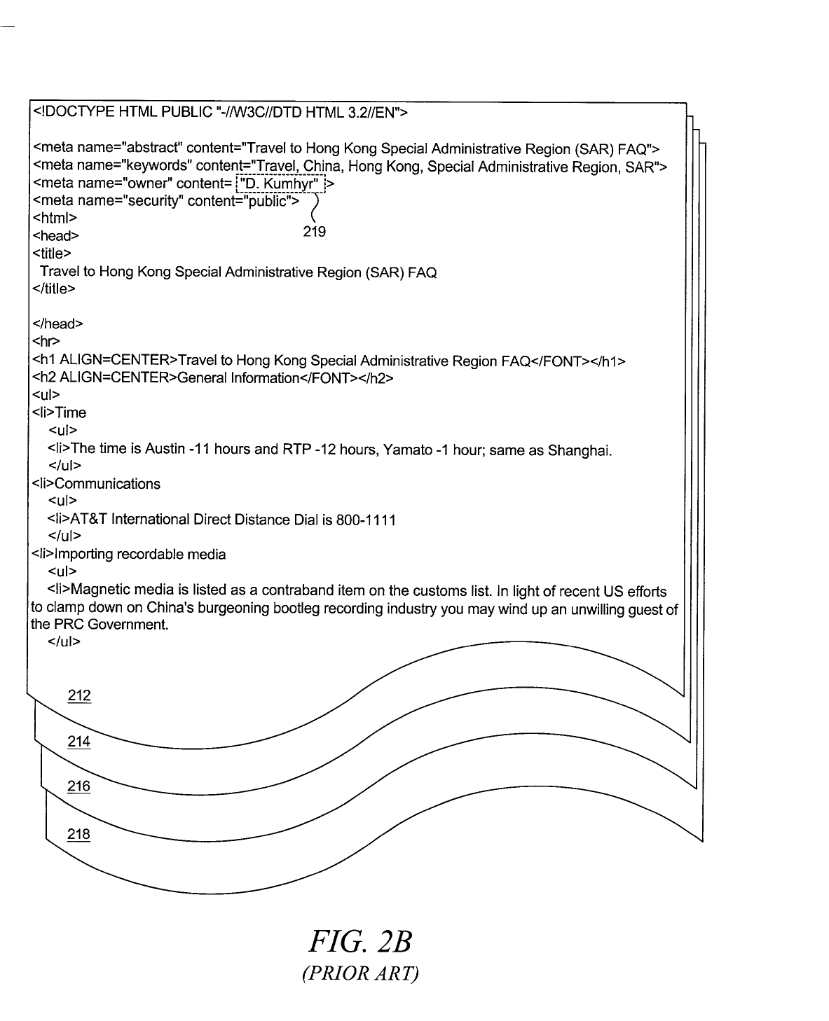

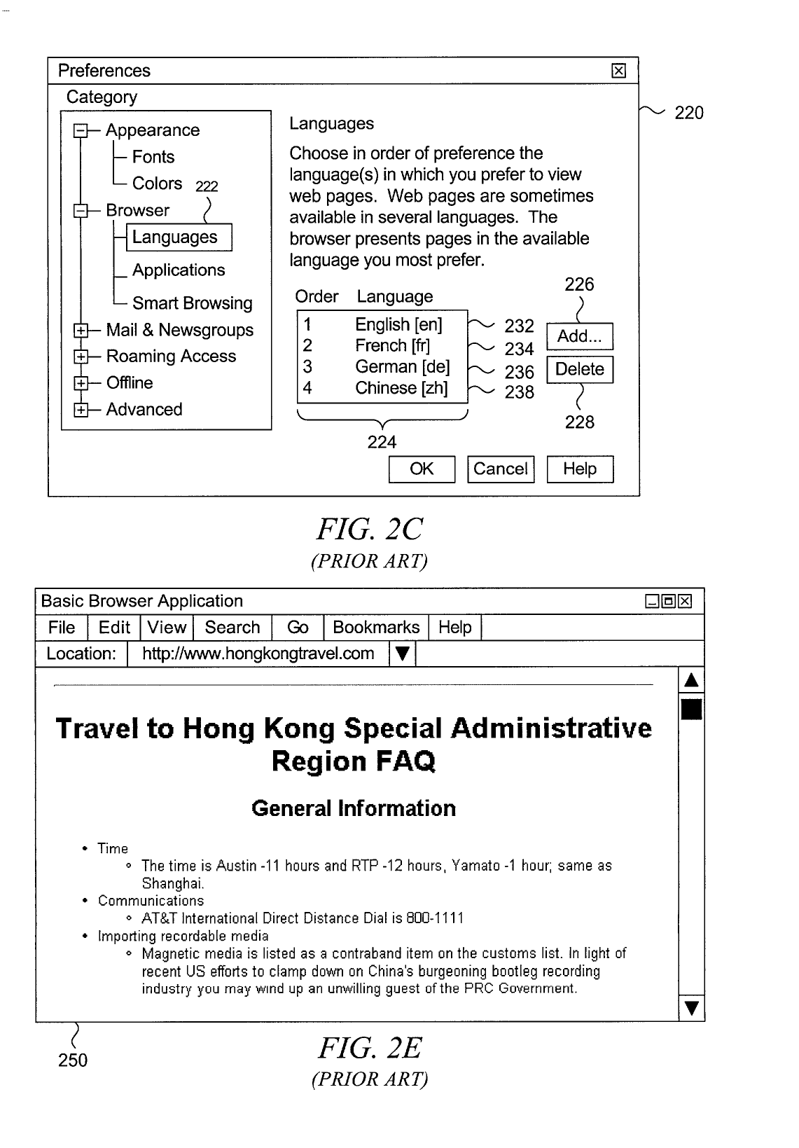

With reference now to FIG. 2A, a block diagram depicts an organization of Web pages that may be used to publish multilingual content within a single Web site. Web pages within a Web site are connected by hyperlinks, and a set of Web pages within a Web site can be viewed as being organized such that the hyperlinks between Web pages create a type of logical hierarchy. FIG. 2A depicts a typical Web site with connections between the Web pages. An English-language Web home page 202 may be found at a particular Uniform Resource Locator (URL), such as “www.ibm.com”, which represents the main Web page for the domain “ibm.com”.

A set of foreign language Web pages may branch from English home page 202, which can be shown as being subordinate to the home page because the foreign language Web pages are found at URLs that are subordinate to the main domain address. For example, the URL for French Web page 204 is “www.ibm.com/fr/”; similarly, German Web page 206 is located at address “www.ibm.com/de/”, and Chinese Web page 208 is located at address “www.ibm.com/zh/”.

FIG. 2A shows that Web pages 202-208 serve as the main Web page for a portion of the Web site that contains Web pages with content in the same foreign language as the corresponding main Web page. For example, a user at a client machine connected to the Internet may operate a browser application to direct it to address “www.ibm.com”, from which the user could navigate a set of Web pages in which the content is written in the English language. The user could then select one of a set of hyperlinks on English home page 202 to access Web pages in a foreign language, such as French Web page 204, from which the user may navigate a set of Web pages in which the content is written in the French language.

Web pages 202-208 may have hyperlinks between each of the other foreign language main pages. As shown in FIG. 2A, each foreign language portion of the Web site has the same logical structure within its Web pages as the other foreign language portions of the Web site. While this type of organization might not be true in many multilingual Web sites, this type of organization is advantageous because all of the content that is available within the Web site is equally reflected in each foreign language portion of the Web site. Therefore, no visitor to the Web site is presented with a lack of content due to a lack of effort by the Web site operator to translate any content into all of the available languages.

However, in order to maintain the multilingual Web site, the Web site operator experiences an increase in effort and costs that are linearly proportional to the number of languages that the Web site makes available.

With reference now to FIG. 2B, a diagram depicts a set of typical HTML source documents for a multilingual set of Web pages. Document 212 contains the HTML source code for a Web page with content in the English language, while documents 214, 216, and 218 contain the HTML source code for three other Web pages with similar content but in different foreign languages. Continuing with the example in FIG. 2A, document 212 may contain the HTML source code for English home page 202, while documents 214, 216, and 218 contain the HTML source code for French Web page 204, German Web page 206, and Chinese Web page 208. In this example, it is assumed that Web pages 204-208 are merely foreign language versions of English Web page 202.

While it is well-known that content within many Web pages can have variable portions that are provided on-the-fly by evaluating Java™ script language statements, server-side Common Gateway Interface (CGI) scripts, etc., the HTML source code shown in FIG. 2B does not have any variable content. Particular attention is drawn to content string 219 that represents the name of the owner of the Web page as indicated by the meta-tag “owner”. Content string 219 is static, i.e., constant, and does not vary; the significance of this characteristic will be explained in more detail further below.

With reference now to FIG. 2C, a diagram depicts a typical graphical user interface (GUI) window through which a user may set preference parameters for a browser application. Window 220 contains a variety of preference options that a user may select to control various operational aspects of a browser application. “Languages” option 222 has been selected, thereby presenting an additional set of language options within window 220. List 224 contains a set of preferred languages in an order of preference. “Add” button 226 and “Delete” button 228 are used to add and delete languages from a master list of languages that are supported by the browser. In this example, “English” list item 232, “French” list item 234, “German” list item 236, and “Chinese” list item 238 have been selected by a user. The browser retrieves Web pages for the user in accordance with the ordered list of preferred languages as explained in more detail further below.

With reference now to FIG. 2D, a diagram depicts a trace of a typical HTTP GET message. The present invention may be implemented in a variety of manners that are not dependent on the use of the HTTP protocol between the client and the server. However, the present invention is compatible with the HTTP protocol.

In most cases, HTTP is the protocol that is used to transfer Web pages from a server to a client. One manner for a client to request a Web page from a server is to send an HTTP GET message to the server, such as that shown in FIG. 2D. The HTTP specification contains several internationalization features for various purposes, such as for indicating the character encoding of a page sent from the server to the client or for indicating the character encodings understood by the client to the server. The internationalization feature that is important for the present invention is the ability to indicate to a server the language or languages that are understood by the user of a browser application at the client, sometimes referred to as “language negotiation”. Through the use of the “Accept-Language”request header, the client sends its language preferences to the server, and the server may attempt to provide a Web page in one of the preferred languages, although the server is not required to do so. Header line 240 shows that the HTTP GET message in the trace output contains an indication for the English language as the preferred language.

With reference now to FIG. 2E, a diagram depicts a typical browser application window. Window 250 displays the contents of a Web page that has been received by a browser application in response to a request that has been sent to a server. Assuming that the user of the browser application had selected one or more preferred languages in a manner similar to that shown in window 220 of FIG. 2C, then the browser application would send the preferred language information to a server that supports the Web site located at the Web address specified by the user.

Continuing with the multilingual Web site shown in FIG. 2A, the Web site might be operated in such a way that the server attempts to match the returned Web page to the preferred language of the user as indicated in the HTTP GET message received by the server from the user's client machine. In a first example, a user may have selected the English language as the user's only preferred language within the browser application. In accordance with the user's selected language preference, the browser application might generate an HTTP GET message similar to that shown in FIG. 2D, which indicates the English language as the most preferred language. In response, the server might return English home page 202 in FIG. 2A; in other words, the server might return HTML document 212 shown in FIG. 2B in the response message. In a second example, a user may have selected the French language as the user's only preferred language within the browser application. In accordance with the user's selected language preference, the browser application might generate an HTTP GET message similar to that shown in FIG. 2D but which indicates the French language as the most preferred language. In response, the server might return French Web page 204 in FIG. 2A; in other words, the server might return HTML document 214 shown in FIG. 2B in the response message. In this manner, the server varies its response with the preferences that have been previously indicated by the user within the browser without requiring that the user find a hyperlink within the English Web page that retrieves the French Web page for the user only after the user has selected the hyperlink.

The HTTP internationalization features facilitate the operation of multilingual Web sites, thereby allowing Web site operators to present Web pages in a manner that promotes communication between the consumers of content and the publishers of content. The users of browser applications can find content more quickly in a preferred language, which may help a Web site operator to sell more products or to service existing customers. However, as noted previously, the Web site operator still has the burden of publishing content in multiple languages. In an attempt to ease this burden, the present invention is directed to a system and a methodology for generating multilingual Web pages as described in more detail with respect to the remaining figures.

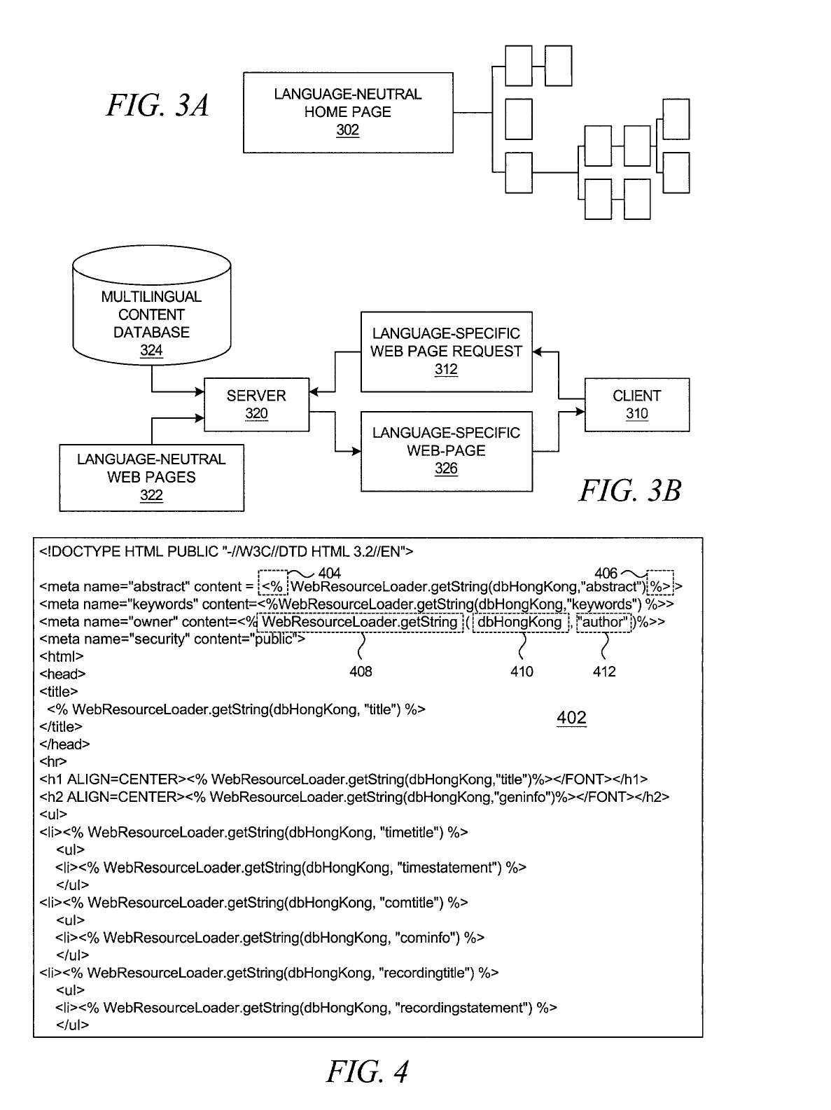

With reference now to FIG. 3A, a block diagram depicts an organization of language-neutral Web pages that may be used to publish multilingual content within a single Web site in accordance with the present invention. In a manner similar to that shown in FIG. 2A, FIG. 3A depicts a Web site with connections between the Web pages. Again, Web pages within a Web site are connected by hyperlinks, and a set of Web pages within a Web site can be viewed as being organized such that the hyperlinks between Web pages create a type of logical hierarchy.

In FIG. 3A, though, a language-neutral home page 302 may be found at a URL that points to the home Web page for a domain; the other pages within the Web site may also be language-neutral. Although this example discusses a home page, the present invention is applicable to any given Web page without regard to its logical position within a domain or a set of Web pages. It should also be noted that the present invention does not have to be applied to all Web pages within an entire Web site in order to be useful; the present invention is also useful for a single Web page.

It is important to note the following distinctions. Web pages may comprise a variety of “languages”, including computer-oriented languages and human languages. For example, the content within a Web page may be written in one or more human languages, such as English and French. At the same time, the Web page may contain one or more computer-oriented languages, such as a markup language for coding the structure of the document and the presentation parameters of the document in addition to script language statements that, when evaluated, provide dynamically generated content. Hence, with respect to the present invention, the terms “language-specific”, “language-neutral”, and “multilingual” refer to the content portions of a document that are written in human languages.

With reference now to FIG. 3B, a block diagram depicts a data processing system that may be used to store language-neutral Web pages that support the presentation of a multilingual Web site in accordance with the present invention. Client 310 sends language-specific Web page request 312 to server 320. Although the present invention is not dependent upon the use of a particular communication protocol between the client and the server, the language-specific Web page request may be similar to the HTTP GET message shown in FIG. 2D.

Server 320 retrieves language-neutral Web page document 322 that corresponds to the URL that was specified within the HTTP GET message. Server 320 then performs server-side processing on language-neutral Web page document 322, which contains server-side directives that indicate the location of language-specific content strings to be inserted into the Web page in accordance with user-specified language preferences. A server-side directive is an identifier for invoking a process, application, server plug-in, applet, script, function, or their equivalents to perform some type of processing on behalf of the server. In this case, the server-side directives require the retrieval of content strings from multilingual content database 324; hence, these directives may be termed “content directives”. Server 320 inserts language-specific content strings into particular locations within the language-neutral Web page document, thereby replacing the directives. In effect, server 320 generates on-the-fly a content stream that represents the Web page at the specified URL, and server 320 then returns to client 310 an HTTP response message with a content portion that contains the generated content stream, i.e., language-specific Web page 326. Client 310 then presents the Web page to the user.

With reference now to FIG. 4, a diagram depicts a language-neutral HTML source document that may be used to provide multiple language-specific versions of a Web page in accordance with the present invention. A server process may parse retrieved documents for server-side directives that direct the server to perform certain actions with respect to the document. As described above with respect to FIG. 3B, a server can retrieve and process a language-neutral Web page, such as Web page document 322 shown in FIG. 3B, in order to generate a language-specific Web page. Document 402 in FIG. 4 shows more detail for language-neutral Web page 322 in FIG. 3B.

As noted above, in the present invention, a server processes a language-neutral Web page document that contains server-side directives that indicate the location of language-specific content strings to be inserted into the Web page in accordance with user-specified language preferences. In this example, document 402 contains special escape sequences 404 and 406 that act as delimiters to demarcate the server-side directives. Directive 408 calls a function to obtain a string from a database, and the function accepts input parameters. Input parameter 410 indicates the database (or portion of a database or other datastore) to be used to during the string retrieval operation, and input parameter 412 indicates an identifier for the specific content string that is to be retrieved from the specified database. Other input parameters may be used with the server-side directives. It should be noted that the type of server-side directives or the format for specifying server-side directives within the language-neutral Web page may depend on several factors, such as the runtime environment for the server.

After retrieving the identified content strings from a content database, the server inserts the retrieved content strings into particular locations within the language-neutral Web page document, thereby replacing the directives. FIG. 4 continues the example of a Web page that was used with respect to FIG. 2B; document 402 is a language-neutral version of the HTML document 212 in FIG. 2B.

By comparing document 402 and document 212, it should be apparent that document 402 and document 212 have the same internal structure. However, for each content string within document 212, a server-side directive has been used in place of the content string. Each content string has been coded with an identifier, such as identifier 412, that determines which content string is to be retrieved for that particular location within the Web page. Each Web page has been coded with an identifier, such as identifier 410, that determines which database or portion of a database is to be used for the content string retrieval process. Document 402 essentially contains not only no language-specific content but rather no content at all; all of the content is placed into the Web page upon completion of the processing of the server-side directives.

Alternatively, document 402 could contain some form of default content for each server-side directive. It is possible that the server could retrieve the Web page but could not establish a connection with the database to perform the lookup operations for the content strings. Rather than sending a content-empty Web page to the client, the server could remove the server-side directives and use the default content strings. In this case, the Web page would contain some content that would be displayed to the user.

It should be noted that a server-side directive does not necessarily need to be completely statically specified. For example, identifiers 410 and 412 could be dynamically generated as output from another directive or process. It should also be noted that more than one database or portion of a database may be used to retrieve content strings.

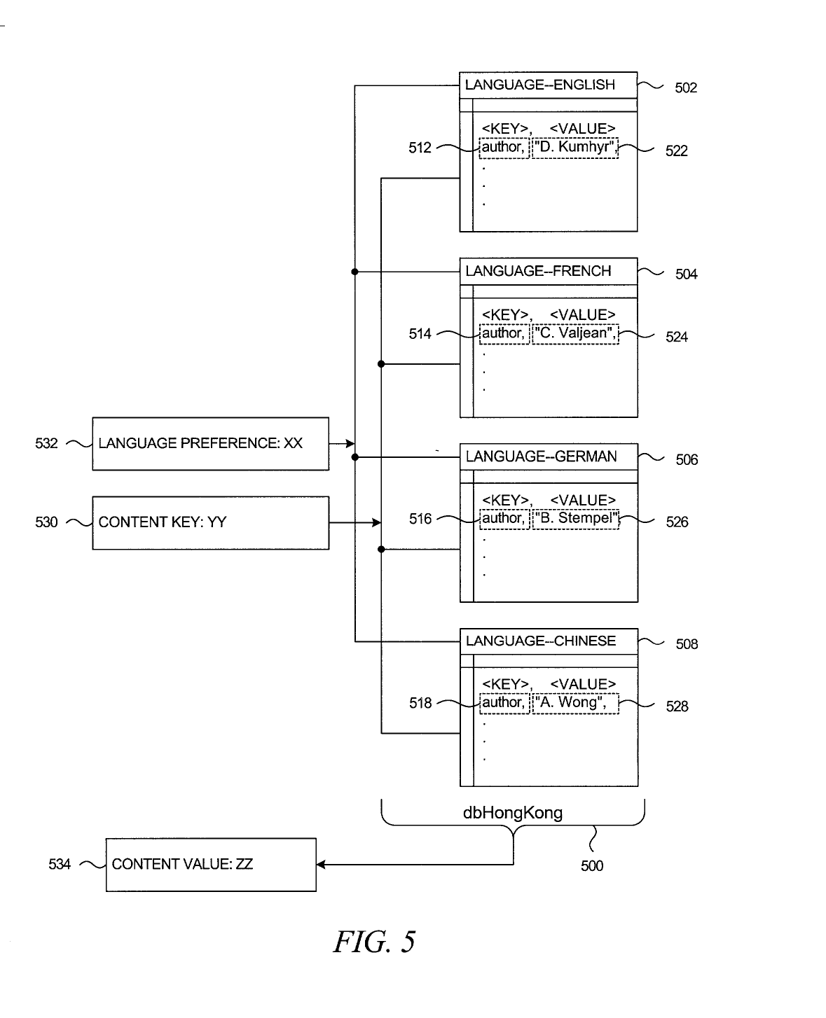

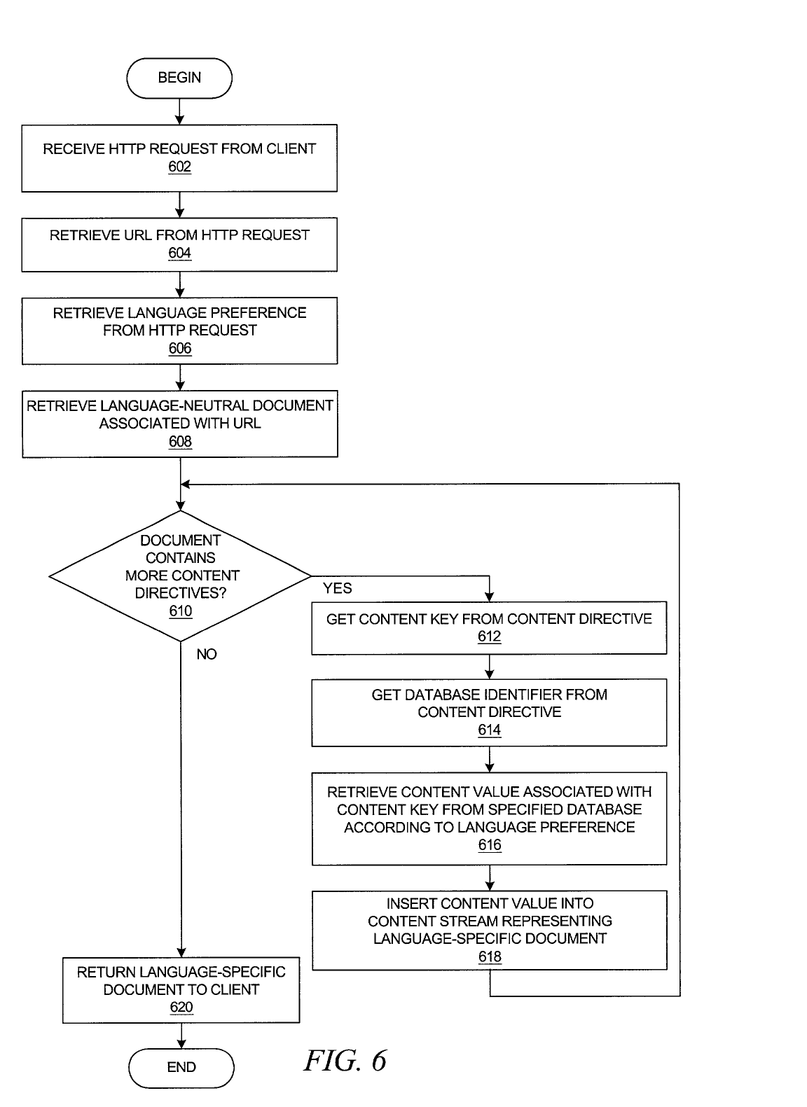

While document 402 represents a language-neutral document, it also represents a content-empty document, as noted above. The server inserts the retrieved content strings into particular locations within the Web page document, but document 402 does not indicate or specify anything in a language-specific manner. Document 402 may be used to generate multiple language-specific versions of a single language-neutral document, but the language-neutral document merely indicates the locations/identities of the content strings to be placed within the Web page data stream that is being generated. The manner in which a language-specific version of the language-neutral document is generated is explained in more detail with respect to FIG. 5 and FIG. 6.

With reference now to FIG. 5, a block diagram depicts a language-specific content string retrieval process in accordance with a preferred embodiment of the present invention. As noted above, the server-side directives within a language-neutral Web page document may have input parameters for controlling various aspects of the content string retrieval process. As shown in the example in FIG. 4, parameter 410 controls the database or portion of the database from which the content string is retrieved, and parameter 412 identifies the particular content string to be retrieved.

Continuing with the exemplary directives in FIG. 4, FIG. 5 shows the manner in which the parameters for the server-side directive can be used in conjunction with a user-specified language preference parameter to select a language-specific content string to be placed in the Web page output stream in accordance with a preferred embodiment of the present invention. Parameter 410 is used as database selector or database portion selector 500. The selected database or selected portion of a database, such as multilingual content database 324 in FIG. 3, contains multiple sets of language-specific content strings, such as English language set 504, French language set 506, German language set 508, and Chinese language set 510. For each supported language, a given set of language-specific content strings is represented by multiple key-value pairs that contain the individual content strings.

Each language set contains an “author” key; language sets 502-508 contain “author” keys 512-518. Each “author” key is paired with a value; keys 512-518 are paired with values 522-528. Values 522-528 are language-specific content strings that may be used during the language-specific Web page generation process. Continuing with the exemplary directives in FIG. 4, parameter 412 specified the “author” key. Continuing with the example in FIG. 2B, by comparing document 402 with document 212, it can be seen that “author” key 512 in English language set 502 is used to identify content string value 522 that replaced content string 219 within the “owner” meta-tag in document 212.

The content string retrieval process operates as follows. As mentioned above, parameter 410 is used as database selector or database portion selector 500. In addition, parameter 412 is used as content key selector 530. Furthermore, the user-specified language preference parameter, such as parameter 240 within an HTTP GET message, is used as language preference selector 532. Using all three selectors, content string 534 is then retrieved, and the content string may be inserted into the output data stream for the Web page that is sent to the client in response to the client's request, similar to language-specific Web page 326 in FIG. 3.

With reference now to FIG. 6, a flowchart depicts a process for generating language-specific Web pages using a language-specific content string retrieval process in conjunction with a language-neutral Web page in accordance with a preferred embodiment of the present invention. The process begins by receiving a language-specific HTTP request message from a client at a server (step 602). A URL (or more generally, a Uniform Resource Identifier or URI, which is a superset of identifiers that includes URLs as one type of URI) is then retrieved from the HTTP request message (step 604) along with a user-specified language preference (step 606). The server then retrieves the language-neutral Web page document that is associated with the retrieved URL (step 608).

A determination is then made as to whether or not there are unprocessed content directives within the language-neutral document (step 610). If so, then the process gets the content key that is specified in the content directive (step 612) and gets the database identifier that is also specified in the content directive (step 614). The content key and the database identifier are then used in conjunction with the retrieved user-specified language preference to retrieve a content value, i.e., content string (step 616). The content string is then inserted into the content stream that is being generated as a language-specific Web page document (step 618). If there are no more unprocessed content directives within the language-neutral document, as determined at step 610, then the language-specific document is sent to the client (step 620), and the process is complete.

The advantages of the present invention should be apparent in view of the detailed description of the invention that is provided above. In the prior art, the HTTP internationalization features facilitate the operation of multilingual Web sites, thereby allowing Web site operators to present Web pages in a manner that promotes communication between the consumers of content and the publishers of content. However, the Web site operator still has the burden of publishing content in multiple languages.

Assuming that all of the Web pages within a given Web site are maintained in accordance with the present invention, the Web site operator would not be required to maintain separate but similar Web pages for each supported foreign language. Instead, the Web site operator may more easily publish multilingual content in a variety of languages by using a single language-neutral Web page to represent each Web page that contains human language content. Rather than maintaining multiple language-specific Web pages for a particular Web page, a single language-neutral Web page is maintained, and the language-specific content strings for the language-neutral Web page are dynamically retrieved in accordance with the user's specification of a preferred language, which would be received in the client's request message. While the content would still need to be translated and stored, it would no longer be necessary to ensure that updates to one language-specific document was matched with simultaneous updates of multiple, language-specific documents.

Besides having the advantage of uniformly dispensing the translated content, with the present invention, it would no longer be necessary to perform other updates on multiple language-specific documents. For example, maintaining hyperlink integrity among all of the Web pages on a Web site can be complex and tedious, even if an automated software utility is used for that purpose. With the present invention, the Web site operator maintains the hyperlink integrity of a single language-neutral Web page instead of multiple language-specific Web pages.

Moreover, the present invention is compatible with existing communication protocols and does not require any additional features or parameters to be added to a communication protocol. All of the novel features of the present invention are limited to server-side processing steps such that typical, commercially-available browser applications may be used with the present invention without modification or without additional parameter selections by the user of a browser application.

It is important to note that while the present invention has been described in the context of a fully functioning data processing system, those of ordinary skill in the art will appreciate that some of the processes associated with the present invention are capable of being distributed in the form of instructions in a computer readable medium and a variety of other forms, regardless of the particular type of signal bearing media actually used to carry out the distribution. Examples of computer readable media include media such as EPROM, ROM, tape, paper, floppy disc, hard disk drive, RAM, and CD-ROMs and transmission-type media, such as digital and analog communications links.

The description of the present invention has been presented for purposes of illustration but is not intended to be exhaustive or limited to the disclosed embodiments. Many modifications and variations will be apparent to those of ordinary skill in the art. The embodiments were chosen to explain the principles of the invention and its practical applications and to enable others of ordinary skill in the art to understand the invention in order to implement various embodiments with various modifications as might be suited to other contemplated uses.

What is claimed is:

1. A method for processing a document, the method comprising:
retrieving a document;
detecting a content directive within the document;
obtaining a content key from the content directive;
retrieving a content string associated with the content key from a datastore in accordance with a language preference parameter; and
replacing the content directive with the content string in a modified version of the document.

2. The method of claim 1 further comprising:
sending the modified version of the document to a client.

3. The method of claim 1 further comprising:
retrieving a datastore identifier from the content directive; and
selecting, in accordance with the datastore identifier, the datastore from which to retrieve the content string.

4. The method of claim 1 wherein the retrieved document is a language-neutral document with respect to its content.

5. The method of claim 1 wherein the modified version of the document is a language-specific document with respect to its content.

6. The method of claim 1 further comprising:
receiving a request for the document from a client;
retrieving the language preference parameter from the request.

7. The method of claim 6 further comprising:
determining that the request is an HTTP (Hypertext Transport Protocol) request message;
parsing the HTTP request message for a URI (Uniform Resource Identifier) that identifies the document.

8. The method of claim 7 further comprising:
sending the modified version of the document to a client in an HTTP response message.

9. An apparatus for processing a document, the apparatus comprising:
means for retrieving a document;
means for detecting a content directive within the document;
means for obtaining a content key from the content directive;
means for retrieving a content string associated with the content key from a datastore in accordance with a language preference parameter; and
means for replacing the content directive with the content string in a modified version of the document.

10. The apparatus of claim 9 further comprising:
means for sending the modified version of the document to a client.

11. The apparatus of claim 9 further comprising:
means for retrieving a datastore identifier from the content directive; and
means for selecting, in accordance with the datastore identifier, the datastore from which to retrieve the content string.

12. The apparatus of claim 9 wherein the retrieved document is a language-neutral document with respect to its content.

13. The apparatus of claim 9 wherein the modified version of the document is a language-specific document with respect to its content.

14. The apparatus of claim 9 further comprising:
means for receiving a request for the document from a client;
means for retrieving the language preference parameter from the request.

15. The apparatus of claim 14 further comprising:
means for determining that the request is an HTTP (Hypertext Transport Protocol) request message;
means for parsing the HTTP request message for a URI (Uniform Resource Identifier) that identifies the document.

16. The apparatus of claim 15 further comprising:
means for sending the modified version of the document to a client in an HTTP response message.

17. A computer program product on a computer readable medium for use in a data processing system for processing a document, the computer program product comprising:
instructions for retrieving a document;
instructions for detecting a content directive within the document;
instructions for obtaining a content key from the content directive;
instructions for retrieving a content string associated with the content key from a datastore in accordance with a language preference parameter; and
instructions for replacing the content directive with the content string in a modified version of the document.

18. The computer program product of claim 17 further comprising:
instructions for sending the modified version of the document to a client.

19. The computer program product of claim 17 further comprising:
instructions for retrieving a datastore identifier from the content directive; and
instructions for selecting, in accordance with the datastore identifier, the datastore from which to retrieve the content string.

20. The computer program product of claim 17 wherein the retrieved document is a language-neutral document with respect to its content.

21. The computer program product of claim 17 wherein the modified version of the document is a language-specific document with respect to its content.

22. The computer program product of claim 17 further comprising:
instructions for receiving a request for the document from a client;
instructions for retrieving the language preference parameter from the request.

23. The computer program product of claim 22 further comprising:
instructions for determining that the request is an HTTP (Hypertext Transport Protocol) request message;
instructions for parsing the HTTP request message for a URI (Uniform Resource Identifier) that identifies the document.

24. The computer program product of claim 23 further comprising:
instructions for sending the modified version of the document to a client in an HTTP response message.
